(19) United States
(12) Patent Application Publication
(10) Pub. No.: US 2023/0177355 A1
(43) Pub. Date: Jun. 8, 2023

(54) AUTOMATED FAIRNESS-DRIVEN GRAPH NODE LABEL CLASSIFICATION

(71) Applicant: International Business Machines Corporation, Armonk, NY (US)

(72) Inventors: Ramasuri Narayanam, Bangalore (IN); Sameep Mehta, Bangalore (IN); Rakesh Rameshrao Pimplikar, Bangalore (IN); Pranay Kumar Lohia, Bangalore (IN)

(21) Appl. No.: 17/543,149

(22) Filed: Dec. 6, 2021

(51) Int. Cl. G06N 5/02; G06K 9/62

(52) U.S. Cl. CPC G06N 5/022; G06K 9/6264

(57) ABSTRACT

Methods, systems, and computer program products for automated fairness-driven graph node label classification are provided herein. A computer-implemented method includes obtaining at least one input graph; predicting one or more node labels associated with the at least one input graph by processing at least a portion of the at least one input graph using a graph node label prediction model, wherein the graph node label prediction model includes at least one loss function; generating an updated version of the graph node label prediction model based at least in part on the one or more predicted node labels and one or more group fairness-based constraints relevant to the at least one input graph; and performing one or more automated actions using the updated version of the graph node label prediction model.

### BACKGROUND

The present application generally relates to information technology and, more particularly, to data processing techniques. More specifically, given a graph along with textual information associated with each node, problems exist with respect to conventional graph processing approaches. For example, conventional approaches commonly face problems in connection with node classification.

### SUMMARY

In at least one embodiment, techniques for automated fairness-driven graph node label classification are provided. An example computer-implemented method includes obtaining at least one input graph, and predicting one or more node labels associated with the at least one input graph by processing at least a portion of the at least one input graph using a graph node label prediction model, wherein the graph node label prediction model includes at least one loss function. The method also includes generating an updated version of the graph node label prediction model based at least in part on the one or more predicted node labels and one or more group fairness-based constraints relevant to the at least one input graph, and performing one or more automated actions using the updated version of the graph node label prediction model.

Another embodiment of the invention or elements thereof can be implemented in the form of a computer program product tangibly embodying computer readable instructions which, when implemented, cause a computer to carry out a plurality of method steps, as described herein. Furthermore, another embodiment of the invention or elements thereof can be implemented in the form of a system including a memory and at least one processor that is coupled to the memory and configured to perform noted method steps. Yet further, another embodiment of the invention or elements thereof can be implemented in the form of means for carrying out the method steps described herein, or elements thereof; the means can include hardware module(s) or a combination of hardware and software modules, wherein the software modules are stored in a tangible computer-readable storage medium (or multiple such media).

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram illustrating system architecture, according to an example embodiment of the invention;

FIG. 2 is a flow diagram illustrating techniques according to an example embodiment of the invention;

FIG. 3 is a system diagram of an example computer system on which at least one embodiment of the invention can be implemented;

FIG. 4 depicts a cloud computing environment according to an example embodiment of the invention; and

FIG. 5 depicts abstraction model layers according to an example embodiment of the invention.

### DETAILED DESCRIPTION

As described herein, at least one embodiment includes automated fairness-driven graph node label classification. Such an embodiment includes enhancing group fairness of a given graph node label classification algorithm by learning at least one classifier (via node labels) wherein group fairness-based constraints are integrated with at least one original loss function as one or more regularization terms. As used herein, group fairness refers to an objective wherein there is no discrimination in achieving favorable outcomes between minority and majority groups of one or more sensitive attributes. Additionally, in such an embodiment, the group fairness constraint is driven by the centrality of the nodes in the given graph such that the penalty for making incorrect prediction of labels for low-degree nodes is high compared to that of high-degree nodes. As used herein, low-degree nodes signify a lower number of neighboring nodes, whereas high-degree nodes signify a larger number of neighboring nodes.

Accordingly, one or more embodiments include determining and/or implementing one or more group fairness measures. For example, and as detailed herein, such an embodiment can include automatically learning and/or implementing a fair node classification algorithm for graph data. By way merely of illustration, consider the following example use case. For a given graph G, at least one embodiment includes training, using any unstructured data, a graph node label prediction model A. Subsequently, such an embodiment includes predicting at least a portion of the labels of the nodes in graph G by processing at least a portion of graph G using the trained graph node label prediction model A. Additionally, such an embodiment includes computing the centrality of each node (e.g., the degree, the betweenness, etc.) and forming at least two groups among the nodes based at least in part on the centrality computations. As used herein, centrality refers to the ranking and influence of a particular node in a network. By way merely of example, to calculate betweenness centrality, at least one embodiment includes taking every node pair of the network and counting how many times a node can interrupt the shortest paths (e.g., geodesic distance) between the two nodes of the pair.

In one or more embodiments, such groups can include, for example, at least one group pertaining to low centrality values and at least one group pertaining to high centrality values, which can signify the level of influence and/or a favorable outcome associated with the given node.

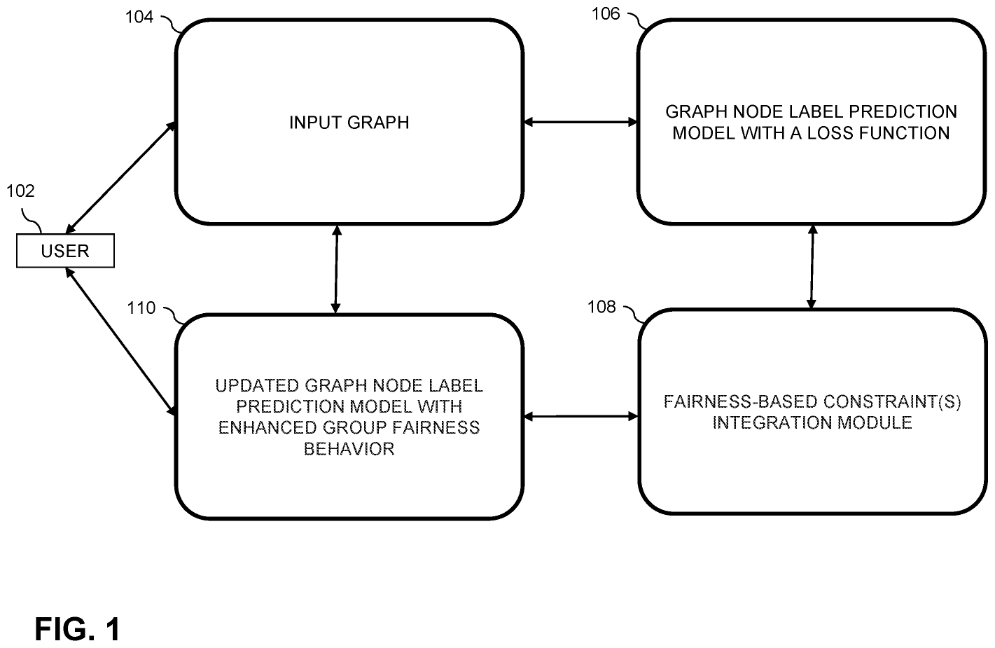

FIG. 1 is a diagram illustrating system architecture, according to an embodiment of the invention. By way of illustration, FIG. 1 depicts a user 102, which provides at least one input graph 104. It is to be appreciated that the term “user” in this context and elsewhere herein is intended to be broadly construed so as to encompass, for example, human, hardware, software or firmware entities, as well as various combinations of such entities. Also, in one or more embodiments, input graph 104 can include, for example, a directed graph, an undirected graph, an unweighted graph, and/or a weighted graph.

As additionally depicted in FIG. 1, the input graph 104 is processed by at least one graph node label prediction model 106 with a loss function. In one or more embodiments, for example, such a graph node label prediction model can include an artificial intelligence-based model such as a graph convolutional network. Such processing results in the prediction of one or more node labels associated with input graph 104. The generated predictions, in addition to the at least one graph node label prediction model 106, are provided as input and processed by fairness-based constraint(s) integration module 108, which automatically learns and/or trains (e.g., by learning the node labels) an updated graph node label prediction model 110 by integrating at least one group fairness-based constraint into the original loss function of model 106 as at least one regularization term.

As used herein, a regularization refers generally to a constraint added to a model loss function to generalize the solution and/or impose certain restrictions of what type of predictions can be generated. Such constraints are assigned by at least one user to modify the corresponding model learning. Also, in one or more embodiments, the group fairness constraint implemented to achieve group fairness in a node classification problem can include, for example, a Kullback-Leibler (KL) divergence term by degree term such as follows:

$$\frac{{D}_{K L} ( P ‖ Q )}{deg ( v , G )} .$$

Accordingly, fairness-based constraint(s) integration module 108 generates updated graph node label prediction model 110 with enhanced group fairness behavior, wherein such an updated model can be output to the user 102 and/or used to process one or more graphs (such as, for example, input graph 104).

As such, and as further detailed herein, one or more embodiments include enhancing the group fairness of any given graph node label classification model by learning at least one classifier wherein one or more group fairness-based constraints are integrated into the original loss function of the model as one or more regularization terms. By way of example, in at least one embodiment, a group fairness-based constraint can be driven by the centrality of the nodes in the given graph such that the penalty for making incorrect predictions of labels for low-degree nodes is high compared to the penalty for making incorrect predictions of labels for high-degree nodes.

In at least one embodiment, enhancing group fairness of a graph node label classification model can include incorporating and/or implementing the following example objective function. By way of illustration, let G=(V,E) be the given graph (wherein “V” stands for vertices and “E” stands for edges) and let V_{T} ⊆V be the set of nodes for which at least one embodiment will predict labels (wherein “T” stands for the set of nodes for which label predictions are needed). Also, let deg(v,G) be the centrality value of any node v in the given graph G. As used above and herein, “V” represents vertices while “v” represents nodes. Additionally, for a given label prediction task, let P(v) be the target pseudo-distribution and Q(v) be the predicted pseudo-distribution of the labels for node v∈G.

Accordingly, in such an example embodiment, enhancing group fairness of a given graph node label classification model can include integrating at least one group fairness-based constraint into the original loss function of the graph node label classification model as at least one regularization term as follows:

$$Loss ( P , Q ) = {\sum }_{v ∈ {G}_{T}} \vert P ( v ) - Q ( v ) \vert \vert log \frac{P ( v )}{Q ( v )} \vert$$

$$Loss ( P , Q ) = {\sum }_{v ∈ {G}_{T}} \vert P ( v ) - Q ( v ) \vert \vert log \frac{P ( v )}{Q ( v )} \vert + \frac{{D}_{K L} ( P ‖ Q )}{deg ( v , G )}$$

As noted, the second term in the second equation above represents the group fairness-based constraint, and the above equations represent an example KL divergence term by degree term.

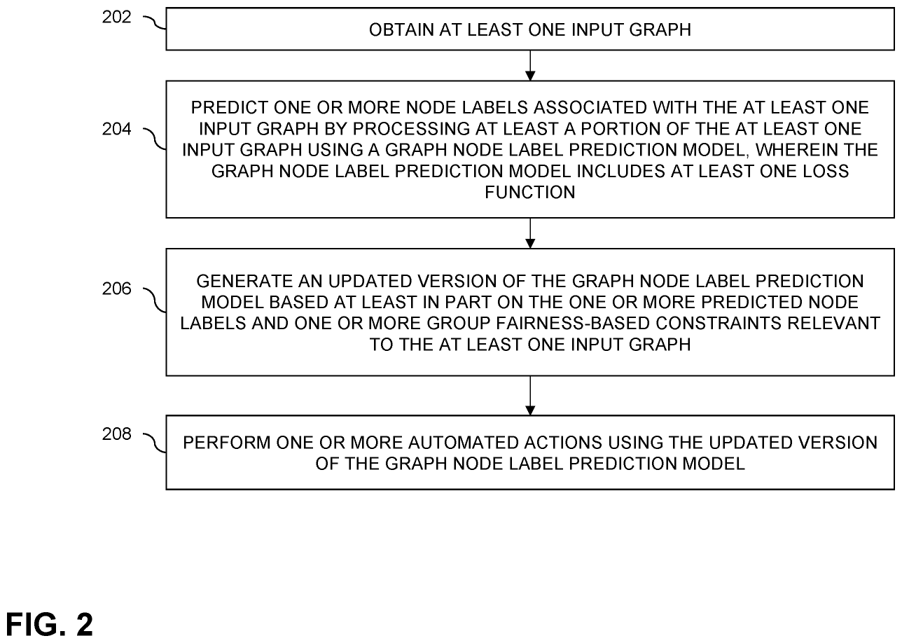

FIG. 2 is a flow diagram illustrating techniques according to an embodiment of the present invention. Step 202 includes obtaining at least one input graph. In one or more embodiments, obtaining at least one input graph includes obtaining at least one of a directed graph, an undirected graph, an unweighted graph, and a weighted graph.

Step 204 includes predicting one or more node labels associated with the at least one input graph by processing at least a portion of the at least one input graph using a graph node label prediction model, wherein the graph node label prediction model includes at least one loss function.

Step 206 includes generating an updated version of the graph node label prediction model based at least in part on the one or more predicted node labels and one or more group fairness-based constraints relevant to the at least one input graph. In at least one embodiment, generating the updated version of the graph node label prediction model includes integrating the one or more group fairness-based constraints into the at least one loss function of the graph node label prediction model as at least one regularization term. Also, one or more embodiments can include learning at least one classifier associated with the one or more group fairness-based constraints.

Additionally or alternatively, at least one embodiment includes determining at least a portion of the one or more group fairness-based constraints based at least in part on one or more centrality measures associated with at least a portion of nodes in the at least one input graph. In such an embodiment, determining at least a portion of the one or more group fairness-based constraints based at least in part on one or more centrality measures includes determining the at least a portion of the one or more group fairness-based constraints such that a penalty for incorrect predictions of labels for one or more low-degree nodes is higher than a penalty for incorrect predictions of labels for one or more high-degree nodes.

Step 208 includes performing one or more automated actions using the updated version of the graph node label prediction model. In one or more embodiments, performing one or more automated actions includes predicting one or more node labels associated with one or more graphs by processing at least a portion of the one or more graphs using the updated version of the graph node label prediction model. In such an embodiment, performing one or more automated actions can also include automatically training the updated version of the graph node label prediction model based at least in part on the one or more predicted node labels associated with the one or more graphs.

Additionally or alternatively, performing one or more automated actions can include outputting the updated version of the graph node label prediction model to at least one user. Further, in at least one embodiment, software implementing the techniques depicted in FIG. 2 can be provided as a service in a cloud environment.

It is to be appreciated that “model,” as used herein, refers to an electronic digitally stored set of executable instructions and data values, associated with one another, which are capable of receiving and responding to a programmatic or other digital call, invocation, or request for resolution based upon specified input values, to yield one or more output values that can serve as the basis of computer-implemented recommendations, output data displays, machine control, etc. Persons of skill in the field find it convenient to express models using mathematical equations, but that form of expression does not confine the models disclosed herein to abstract concepts; instead, each model herein has a practical application in a computer in the form of stored executable instructions and data that implement the model using the computer.

The techniques depicted in FIG. 2 can also, as described herein, include providing a system, wherein the system includes distinct software modules, each of the distinct software modules being embodied on a tangible computer-readable recordable storage medium. All of the modules (or any subset thereof) can be on the same medium, or each can be on a different medium, for example. The modules can include any or all of the components shown in the figures and/or described herein. In an embodiment of the invention, the modules can run, for example, on a hardware processor. The method steps can then be carried out using the distinct software modules of the system, as described above, executing on a hardware processor. Further, a computer program product can include a tangible computer-readable recordable storage medium with code adapted to be executed to carry out at least one method step described herein, including the provision of the system with the distinct software modules.

Additionally, the techniques depicted in FIG. 2 can be implemented via a computer program product that can include computer useable program code that is stored in a computer readable storage medium in a data processing system, and wherein the computer useable program code was downloaded over a network from a remote data processing system. Also, in an embodiment of the invention, the computer program product can include computer useable program code that is stored in a computer readable storage medium in a server data processing system, and wherein the computer useable program code is downloaded over a network to a remote data processing system for use in a computer readable storage medium with the remote system.

An embodiment of the invention or elements thereof can be implemented in the form of an apparatus including a memory and at least one processor that is coupled to the memory and configured to perform exemplary method steps.

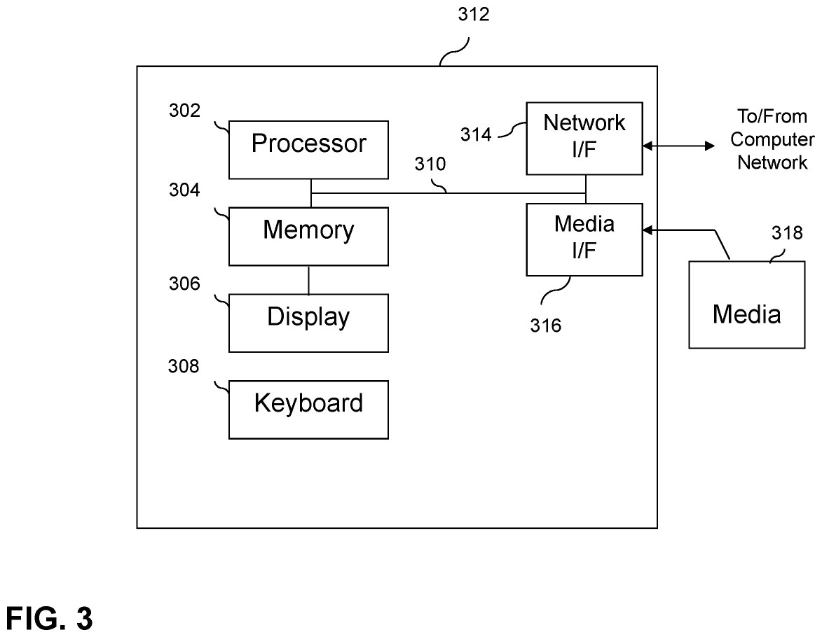

Additionally, an embodiment of the present invention can make use of software running on a computer or workstation. With reference to FIG. 3, such an implementation might employ, for example, a processor 302, a memory 304, and an input/output interface formed, for example, by a display 306 and a keyboard 308. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, a mechanism for inputting data to the processing unit (for example, mouse), and a mechanism for providing results associated with the processing unit (for example, printer). The processor 302, memory 304, and input/output interface such as display 306 and keyboard 308 can be interconnected, for example, via bus 310 as part of a data processing unit 312. Suitable interconnections, for example via bus 310, can also be provided to a network interface 314, such as a network card, which can be provided to interface with a computer network, and to a media interface 316, such as a diskette or CD-ROM drive, which can be provided to interface with media 318.

Accordingly, computer software including instructions or code for performing the methodologies of the invention, as described herein, may be stored in associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 302 coupled directly or indirectly to memory elements 304 through a system bus 310. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including, but not limited to, keyboards 308, displays 306, pointing devices, and the like) can be coupled to the system either directly (such as via bus 310) or through intervening I/O controllers (omitted for clarity).

Network adapters such as network interface 314 may also be coupled to the system to enable the data processing system to become coupled to other data processing systems or remote printers or storage devices through intervening private or public networks. Modems, cable modems and Ethernet cards are just a few of the currently available types of network adapters.

As used herein, including the claims, a “server” includes a physical data processing system (for example, system 312 as shown in FIG. 3) running a server program. It will be understood that such a physical server may or may not include a display and keyboard.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It should be noted that any of the methods described herein can include an additional step of providing a system comprising distinct software modules embodied on a computer readable storage medium; the modules can include, for example, any or all of the components detailed herein. The method steps can then be carried out using the distinct software modules and/or sub-modules of the system, as described above, executing on a hardware processor 302. Further, a computer program product can include a computer-readable storage medium with code adapted to be implemented to carry out at least one method step described herein, including the provision of the system with the distinct software modules.

In any case, it should be understood that the components illustrated herein may be implemented in various forms of hardware, software, or combinations thereof, for example, application specific integrated circuit(s) (ASICS), functional circuitry, an appropriately programmed digital computer with associated memory, and the like. Given the teachings of the invention provided herein, one of ordinary skill in the related art will be able to contemplate other implementations of the components of the invention.

Additionally, it is understood in advance that implementation of the teachings recited herein are not limited to a particular computing environment. Rather, embodiments of the present invention are capable of being implemented in conjunction with any type of computing environment now known or later developed.

For example, cloud computing is a model of service delivery for enabling convenient, on-demand network access to a shared pool of configurable computing resources (for example, networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (for example, country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (for example, storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (for example, web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (for example, host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (for example, mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (for example, cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

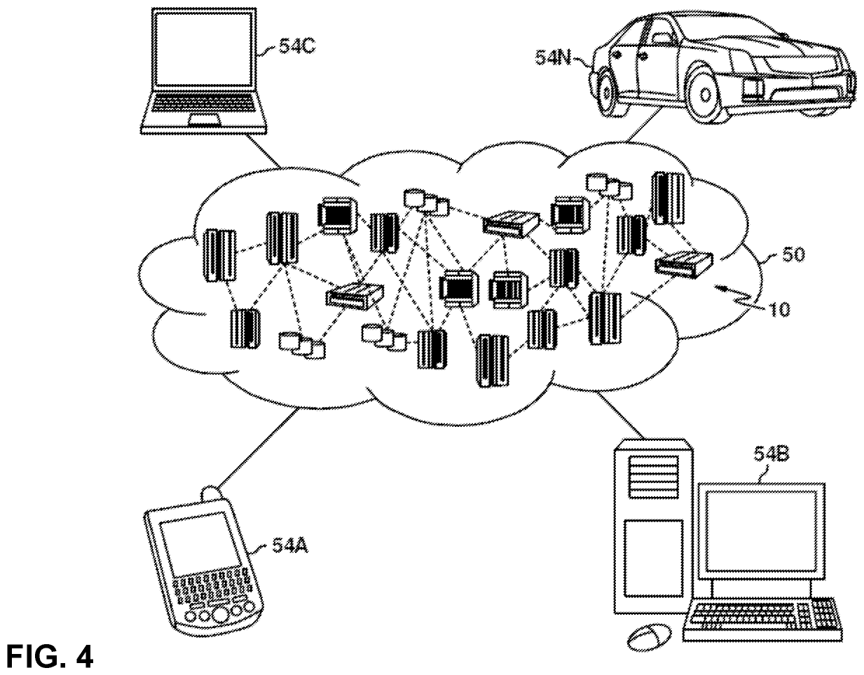

Referring now to FIG. 4, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 10 and cloud computing environment 50 can communicate with any type of computerized device over any type of network and/or network addressable connection (e.g., using a web browser).

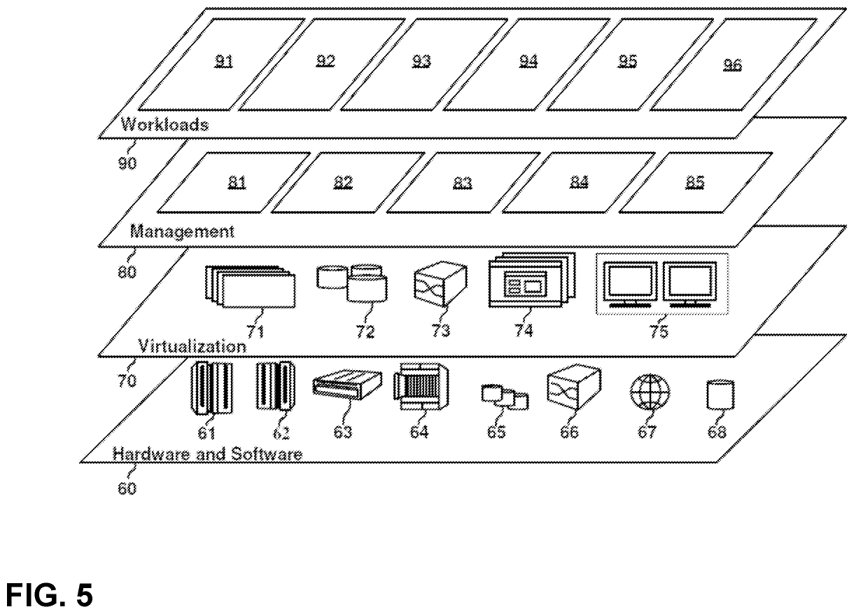

Referring now to FIG. 5, a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75. In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources.

In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and node label classification 96, in accordance with the one or more embodiments of the present invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of another feature, step, operation, element, component, and/or group thereof.

At least one embodiment of the present invention may provide a beneficial effect such as, for example, automated fairness-driven graph node label classification.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
obtaining at least one input graph;
predicting one or more node labels associated with the at least one input graph by processing at least a portion of the at least one input graph using a graph node label prediction model, wherein the graph node label prediction model includes at least one loss function;
generating an updated version of the graph node label prediction model based at least in part on the one or more predicted node labels and one or more group fairness-based constraints relevant to the at least one input graph; and
performing one or more automated actions using the updated version of the graph node label prediction model;
wherein the method is carried out by at least one computing device.

2. The computer-implemented method of claim 1, wherein generating the updated version of the graph node label prediction model comprises integrating the one or more group fairness-based constraints into the at least one loss function of the graph node label prediction model as at least one regularization term.

3. The computer-implemented method of claim 1, further comprising:
learning at least one classifier associated with the one or more group fairness-based constraints.

4. The computer-implemented method of claim 1, further comprising:
determining at least a portion of the one or more group fairness-based constraints based at least in part on one or more centrality measures associated with at least a portion of nodes in the at least one input graph.

5. The computer-implemented method of claim 4, wherein determining at least a portion of the one or more group fairness-based constraints based at least in part on one or more centrality measures comprises determining the at least a portion of the one or more group fairness-based constraints such that a penalty for incorrect predictions of labels for one or more low-degree nodes is higher than a penalty for incorrect predictions of labels for one or more high-degree nodes.

6. The computer-implemented method of claim 1, wherein performing one or more automated actions comprises predicting one or more node labels associated with one or more graphs by processing at least a portion of the one or more graphs using the updated version of the graph node label prediction model.

7. The computer-implemented method of claim 6, wherein performing one or more automated actions comprises automatically training the updated version of the graph node label prediction model based at least in part on the one or more predicted node labels associated with the one or more graphs.

8. The computer-implemented method of claim 1, wherein performing one or more automated actions comprises outputting the updated version of the graph node label prediction model to at least one user.

9. The computer-implemented method of claim 1, wherein obtaining at least one input graph comprises obtaining at least one of a directed graph, an undirected graph, an unweighted graph, and a weighted graph.

10. The computer-implemented method of claim 1, wherein software implementing the method is provided as a service in a cloud environment.

11. A computer program product comprising a computer readable storage medium having program instructions embodied therewith, the program instructions executable by a computing device to cause the computing device to:
obtain at least one input graph;
predict one or more node labels associated with the at least one input graph by processing at least a portion of the at least one input graph using a graph node label prediction model, wherein the graph node label prediction model includes at least one loss function;
generate an updated version of the graph node label prediction model based at least in part on the one or more predicted node labels and one or more group fairness-based constraints relevant to the at least one input graph; and
perform one or more automated actions using the updated version of the graph node label prediction model.

12. The computer program product of claim 11, wherein generating the updated version of the graph node label prediction model comprises integrating the one or more group fairness-based constraints into the at least one loss function of the graph node label prediction model as at least one regularization term.

13. The computer program product of claim 11, wherein the program instructions executable by a computing device further cause the computing device to:
learn at least one classifier associated with the one or more group fairness-based constraints.

14. The computer program product of claim 11, wherein the program instructions executable by a computing device further cause the computing device to:
determine at least a portion of the one or more group fairness-based constraints based at least in part on one or more centrality measures associated with at least a portion of nodes in the at least one input graph.

15. The computer program product of claim 14, wherein determining at least a portion of the one or more group fairness-based constraints based at least in part on one or more centrality measures comprises determining the at least a portion of the one or more group fairness-based constraints such that a penalty for incorrect predictions of labels for one or more low-degree nodes is higher than a penalty for incorrect predictions of labels for one or more high-degree nodes.

16. The computer program product of claim 11, wherein performing one or more automated actions comprises predicting one or more node labels associated with one or more graphs by processing at least a portion of the one or more graphs using the updated version of the graph node label prediction model.

17. The computer program product of claim 16, wherein performing one or more automated actions comprises automatically training the updated version of the graph node label prediction model based at least in part on the one or more predicted node labels associated with the one or more graphs.

18. The computer program product of claim 11, wherein performing one or more automated actions comprises outputting the updated version of the graph node label prediction model to at least one user.

19. The computer program product of claim 11, wherein obtaining at least one input graph comprises obtaining at least one of a directed graph, an undirected graph, an unweighted graph, and a weighted graph.

20. A system comprising:
a memory configured to store program instructions; and
a processor operatively coupled to the memory to execute the program instructions to:
obtain at least one input graph;
predict one or more node labels associated with the at least one input graph by processing at least a portion of the at least one input graph using a graph node label prediction model, wherein the graph node label prediction model includes at least one loss function;
generate an updated version of the graph node label prediction model based at least in part on the one or more predicted node labels and one or more group fairness-based constraints relevant to the at least one input graph; and
perform one or more automated actions using the updated version of the graph node label prediction model.
